(19) United States
(12) Patent Application Publication
(10) Pub. No.: US 2012/0034482 A1
(43) Pub. Date: Feb. 9, 2012

(54) FIRE EXTINGUISHING MATERIAL AND FABRICATION METHOD THEREOF

(75) Inventors: Zachary Joseph Zeliff, Kerrville, TX (US); Liana Vladimirovna Loveless, Taipei (TW); Stanislav Vladimirovich Kutsel, Taipei (TW)

(73) Assignee: ATOZ DESIGN LABS CO., LIMITED

(21) Appl. No.: 12/852,350

(22) Filed: Aug. 6, 2010

(51) Int. Cl. A62D 1/02; B32B 23/14; B05D 1/36; B32B 37/00; B05D 1/02; B31B 1/60

(52) U.S. Cl. 428/532; 252/5; 427/421.1; 156/60; 156/182; 427/415; 156/280

(57) ABSTRACT

A flexible planar carrier bears an aerosol-producing fire extinguishing composition. The carrier can be an integral part of the composition when saturated with a solution that, upon combustion of the prepared carrier, produces fire extinguishing aerosol, or can bear the composition, providing structural support and/or thermal insulation, depending on requirements of the specific application. The carrier may have a thermal insulating layer applied on the mounting side, insulating the mounting surface and the prepared material, and may further have a hydrophobic layer applied at least on its active surface. The flexible planar carrier enables a stable, workable application of the composition to be easily deployed along any planar surface, providing instant low-impact extinguishment of flames over a wide area.

### BACKGROUND OF THE INVENTION

1. Field of the Disclosure

The disclosure relates to fire extinguishing in general, and, specifically, to a fire-extinguishing composition carried on a flexible planar carrier and method of fabricating the same.

2. Description of the Related Art

Fire-extinguishing aerosols characterized by the presence of specifically formulated substances containing potassium nitrates and/or perchlorates as an oxidizer and supplier of the main fire-extinguishing agent, and binding fuels of plasticized and non-plasticized polymers, capable of transitioning to viscous or flexible state under the influence of thermal or/and mechanical nature have gained considerable attention in recent years. Among such binding fuels, phenol-formaldehyde and epoxy resins, polyvinyl butyral, cellulose ethers, and rubber are well known.

These aerosols, applied in a variety of environments, offer numerous advantages. In addition to superior extinguishing capabilities for open fire, the aerosols require no central system to operate, being independently deployable. Unlike sprinkler systems or foaming agents, the aerosols, having doused the flames, present no residual damage to furnishings, fixtures, or valuable mechanical and electronic assets. Further, compared to gas extinguishing methods, aerosols require no pressurized container and are significantly less costly.

The aerosols, in addition, provide the choice between remote deployment or automatic triggering in the environment.

Despite the stated advantages, however, some limitations remain. Aerosol producing fire extinguishing devices are traditionally contained in metal canisters or other bulky housings, with cooling agents, additional parts such as screens, spacers, and other parts, contributing significantly to the extinguishing device's overall size and weight. Canisters or other housings of the aerosol require not only requisite space for positioning, but more importantly, modification of the original design of the protected area to provide stable mounting hardware. In addition, the effective area of material deployment is relatively limited by the directional nature of the agent's dispersal. Hence, use of the aerosols in areas with limited space, strict limitations on design modification, or spaces presenting spacial abstractions, such as vehicle engine compartments or areas containing electrical and or/electronic equipment, may be impractical or impossible.

Thus, what is called for is a solution addressing the described limitations.

### BRIEF DESCRIPTION OF THE DRAWINGS

The invention can be more fully understood by reading the subsequent detailed description and examples with references made to the accompanying drawing, wherein:

FIG. 1 is a detailed cross section showing a portion of an exemplary fire extinguishing material as disclosed;

FIG. 2 is a detailed cross section showing a portion of another exemplary fire extinguishing material as disclosed;

FIG. 3 is a flowchart of a fabrication method for a fire extinguishing material as disclosed.

### DETAILED DESCRIPTION OF THE INVENTION

The disclosure provides a fire extinguishing material and a fabrication method thereof.

The fire extinguishing material as disclosed comprises a flexible planar carrier bearing at least an aerosol-producing fire extinguishing composition. The composition retains all the standard fire extinguishing capabilities known in the art to be exhibited by such compounds.

Constituent materials of the composition can include, but are not limited to, nitrates and/or perchlorates of the alkali metals, and cellulose with starch or iditol (phenol-formaldehyde resin). Numerous aerosol producing fire extingushing agents are applicable to the application as long as they constitute fuel (can also be binding fuel) and oxidizer (chemical compounds generating free oxygen when heated). Other constituents can be added to the composition to meet the needs of specific applications, such as cooling agents (dicyandiamide or melamine, for example), and combustion catalysts such as iron (III) or copper nitrates and additional fuel source such as coal powder or starch.

Effective protection is provided by a flexible planar carrier bearing the composition.

In a fire extinguishing material as disclosed, the carrier can be a hydrophilic flammable medium such as a textile of natural fibers such as cotton, paper, cardboard, or other material capable of absorbing the oxidizers and combusting. During deployment the carrier itself acts as an essential component of the aerosol producing composition as its fuel.

Alternatively, the carrier can be a planar matrix and the aerosol-producing fire extinguishing composition further comprises both fuel and oxygen generating components. In this embodiment, the carrier used provides a stable base for composition and serves as an integral structural component. The carrier in this embodiment may further exhibit thermal insulating properties, such as felt of silicon fibers, basalt wool, or any other fibrous mineral insulating material. If desired, the prepared material can serve as a thermal insulating agent for the environment of application.

The composition can be prepared as a solution, in which the carrier is immersed to achieve saturation, as a paste form, spread over the carrier, or as a spray to coat the carrier. The composition can further be manufactured in sheet form and fixed to the carrier by stapling, adhesive, stitching, or other means of attachment. As well, the composition can be mechanically worked into the structure of the carrier by pressing or other procedure. Finally, the composition can be prepared in any other form that allows even distribution of the aerosol producing agent over the surface of the carrier.

It should be noted that the flexible planar carrier prepared as disclosed can comprise bulk yardage lots of the desired carrier, or, alternatively, pieces precut and shaped according to the specific needs of the intended environment.

In addition, the carrier can further be coated on a side to be mounted to a surrounding surface by a thermal insulating layer, preventing the applied composition from loss of heat, and the mounting surface from permanent damage from the heat of combustive deployment.

As well, the finished carrier may further be applied with a hydrophobic layer applied at least on its active surface, thereby protecting the extinguishing composition from degrading moisture and physical impact.

The applied hydrophobic layer can further serve to modify or manage the ignition temperature of the applied composition. If the hydrophobic agent's combustion temperature is below that of the composition, such as if nitrocellulose lacquer is used, applied hydrophobic layer serves as an actual thermal fuse, igniting the composition at a temperature lower than it would otherwise. Alternatively, if the applied hydrophobic layer combustion temperature is higher than that of the composition, it elevates the temperature point at which the composition can ignite. The hydrophobic agent used need not necessarily be combustible as long as it is easily degradable by fire and/or high temperature, such as, for example, aluminum foil, in the case of which ambient temperature must reach 500° C., at which point the foil melts, exposing the aerosol producing composition for deployment.

It should be noted that the carrier can be folded on itself, thereby increasing the amount of aerosol deployed in a given area.

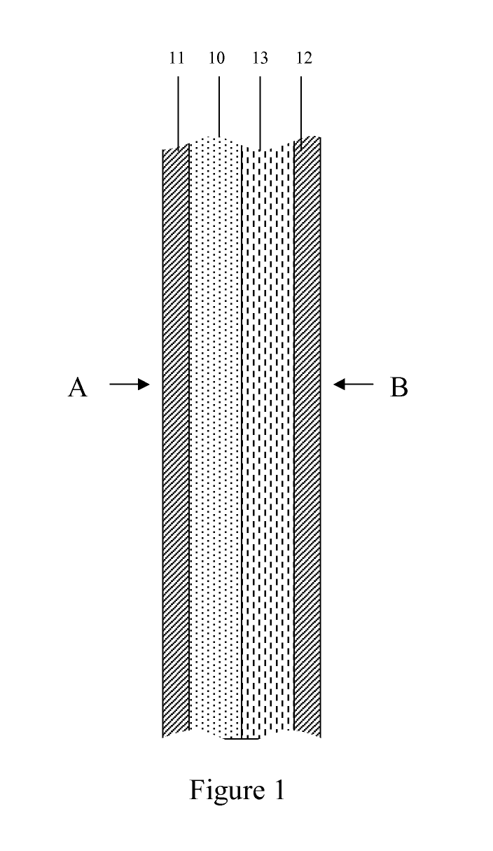

FIG. 1 is a detailed cross section showing a portion of an exemplary fire extinguishing material as disclosed, in which a single layer of carrier 10 is covered by a hydrophobic layer 11 applied on its active surface A, and a second hydrophobic layer 12 and a thermal insulating layer 13 on a side to be mounted B.

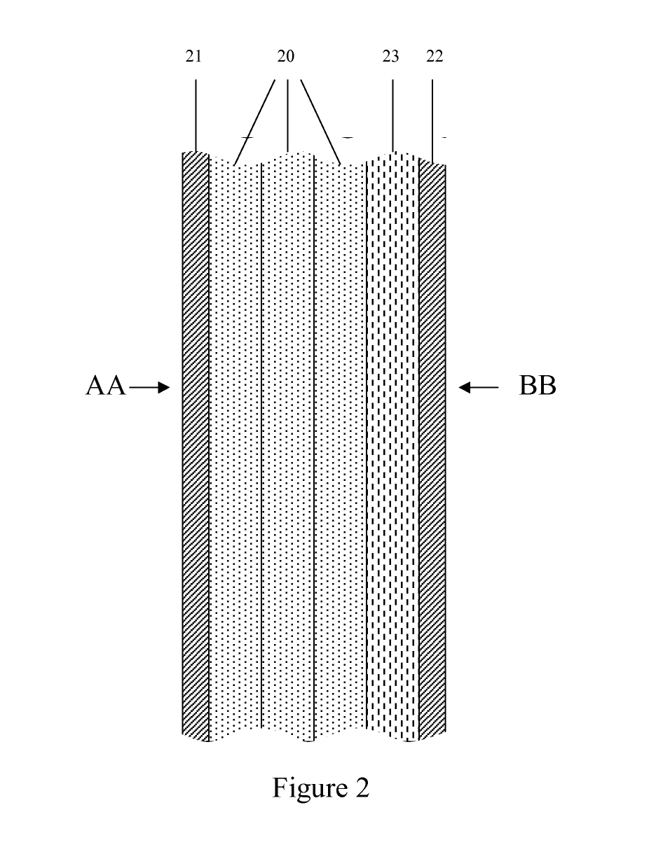

FIG. 2 is a detailed cross section showing a portion of another exemplary fire extinguishing material as disclosed, in which multiple layers of carrier 20 are covered by a hydrophobic layer 21 applied on its active surface AA, and a second hydrophobic layer 22 and a thermal insulating layer 23 on a side to be mounted BB.

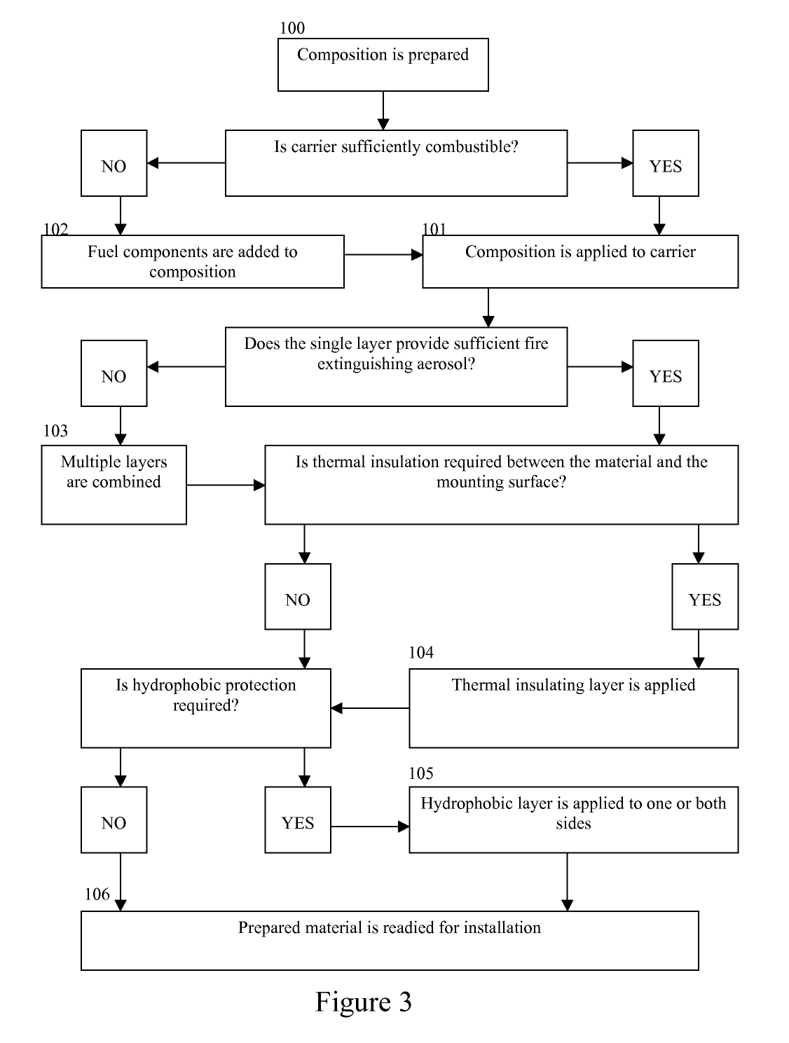

FIG. 3 is a flowchart of a fabrication method for a fire extinguishing material as disclosed.

As shown, In Step 100, a pre-measured amount of oxidizer is prepared, comprising, for example, potassium or sodium nitrates and/or perchlorates. Other constituents can be added to the composition to meet the needs of specific applications, such as cooling agents (ditsiandiamid or melemine, for example), constituting a Part 1 of the composition.

It is determined whether the carrier provides requisite combustibility. If so, Step 101 is implemented, and, if not, Step 102 is implemented, in which at least fuel components are added to the composition. The composition can be prepared as a solution, paste, spray, particulate, a planar sheet unit or other configuration suitable to the chosen carrier that allows even distribution of the aerosol producing agent over the area of the carrier.

In Step 101, the composition is applied to the carrier, by saturation, spreading, spraying, mechanical infusion, fixing, or other method corresponding to the configuration of the composition and the chosen carrier.

It is determined whether a single layer of the carrier provides sufficient aerosol to the intended deployment area. If not, Step 103 is implemented, in which multiple layers of the treated carrier are stacked together, and, if so, it is determined whether thermal insulation between the material and the intended mounting surface is required. If so, Step 104 is implemented, in which a thermal insulating layer is applied to the mounting face of the treated carrier. Further, it is determined whether hydrophobic protection is required. If not, Step 106 is implemented, and, if so, Step 105 is implemented, in which a hydrophobic protection layer is applied to the active face of the treated carrier, or to both the active face and the mounting face of the treated carrier and Step 106 is implemented.

In Step 106, the prepared material is readied for installation.

In use, the finished fire extinguishing material can be fixed to surfaces enclosing the area to be protected. Depending on the required coverage, a single application fixed to the top inner surface of the area, such as the inside of an engine hood or inside of the door of an electrical fuse or breaker box, may provide sufficient protection. Alternatively, additional application of the material to surrounding sidewall surfaces and even a floor, can be employed, for increased coverage. If the configuration of the elements to be protected is suitable, the carrier can even be wrapped around actual elements.

In keeping with the known behavior of such aerosol-producing fire extinguishing compositions, the extinguishing composition is deployed when it ignites and the aerosol is dispersed. Alternatively, a thermal fuse attached to any portion of the installed carrier can implement dispersal. Further, an electrical fuse attached to any portion of the installed carrier and controlled from a remote location can allow controlled dispersal of the aerosol.

The fire extinguishing material as disclosed, comprising a flexible planar carrier bearing an aerosol-producing fire extinguishing composition, provides workable application of the composition to be easily deployed along any planar surface, providing instant low-impact extinguishment of flames over a wide surface area in enclosed areas where deployment of other extinguisher types is unavailable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fire extinguishing material comprising a flexible planar carrier bearing at least an aerosol-producing fire extinguishing composition, the composition comprising:
nitrates and/or perchlorates of alkili metals, combined with fuel such as iditol or cellulose, other aerosol producing fire extingushing agents or a combination thereof
wherein the carrier comprises a stable planar matrix as a composition reinforcement, or a flammable medium capable of sorbing the oxidizers, or a combination thereof and
the composition is prepared in stages as a solution, paste, or spray, in sheet form, as a particulate, or any other form allowing even distribution of the aerosol producing agent over the area of the carrier.

2. The fire extinguishing material of claim 1, wherein the composition impregnates the carrier by saturation, is spread thereon, sprayed thereon, fixed thereon by stapling, adhesive, stitching, or other means of attachment, or mechanically worked into the structure of the carrier by pressing or other procedure.

3. The fire extinguishing material of claim 1, wherein the composition further comprises fuel or binding fuel such as, for example, coal powder or starch, or other performance additives such as dicyandiamide, melamine, iron or copper nitrates, or a combination thereof.

4. The fire extinguishing material of claim 1, wherein the carrier is further coated on a side to be mounted to a surrounding surface by a thermal insulating layer.

5. The fire extinguishing material of claim 1, wherein the carrier is further coated with a hydrophobic layer applied on its active surface, or on both its active surface and mounting surface.

6. The fire extinguishing material of claim 4, wherein the carrier is further coated with a hydrophobic layer applied on its active surface, or on both its active surface and over the thermal insulating layer on its mounting surface.

7. The fire extinguishing material of claim 1, wherein the carrier is multiple layers of the treated carrier are stacked together following treatment with the aerosol fire extinguishing composition, prior to installation or any additional coating procedures.

8. The fire extinguishing material of claim 1, wherein dispersal of the extinguishing composition is triggered by combustion of the flexible planar carrier.

9. The fire extinguishing material of claim 1, wherein dispersal of the extinguishing composition is triggered by ignition of a thermal fuse attached to the flexible planar carrier.

10. The fire extinguishing material of claim 1, wherein dispersal of the extinguishing composition is triggered by activation of an electrical fuse attached to the flexible planar carrier.

11. A fabrication method for a fire extinguishing material, comprising:
preparing a first part of the fire extinguishing aerosol producing composition, comprising nitrates or chlorates, and permanganates or perchlorates for the alkali metals or other oxidizers, or a combination thereof, and a second part, comprising iditol or cellulose with starch or other fuel components or a combination thereof; wherein the composition is prepared as a solution, paste, spray, particulate, planar sheet unit, or any other form allowing even distribution of the aerosol producing agent over the area of the carrier;
wherein part one or the entire composition is applied to a flexible planar carrier by saturation, spreading, spraying, mechanical infusion, or fixing, corresponding to the configuration of the composition and the chosen carrier; and
the prepared material is readied for installation.

12. The fabrication method for a fire extinguishing material of claim 11, wherein, prior to application of the composition to the carrier, fuel or binding fuel such as, for example, coal powder or starch, or additives such as dicyandiamide or melamine and iron or copper nitrates or other performance additives, or a combination thereof are added to the composition.

13. The fabrication method for a fire extinguishing material of claim 11, wherein, following application of the composition to the carrier, multiple layers of the treated carrier are stacked together.

14. The fabrication method for a fire extinguishing material of claim 11, wherein, following application of the composition to the carrier, a thermal insulating layer is applied to the mounting face of the treated carrier.

15. The fabrication method for a fire extinguishing material of claim 13, wherein, following application of the composition to the stacked treated carrier, a thermal insulating layer is applied to the mounting face of the stacked treated carrier.

16. The fabrication method for a fire extinguishing material of claim 11, wherein, following application of the composition to the carrier, a hydrophobic protection layer is applied to the active face of the treated carrier, or to both the active face and the mounting face of the treated carrier.

17. The fabrication method for a fire extinguishing material of claim 13, wherein, following application of the composition to the stacked treated carrier, a hydrophobic protection layer is applied to the active face of the stacked treated carrier, or to both the active face and the mounting face of the stacked treated carrier.
